(19) United States
(12) Patent Application Publication
(10) Pub. No.: US 2005/0147733 A1
(43) Pub. Date: Jul. 7, 2005

(54) Starch-based binding agent

(76) Inventor: Thomas Bruemmer, St. Gallen (CH)

Correspondence Address: JORDAN AND HAMBURG LLP, 122 EAST 42ND STREET, SUITE 4000, NEW YORK, NY, 10168, US

(21) Appl. No.: 10/509,804

(22) PCT Filed: Apr. 17, 2003
(86) PCT No.: PCT/CH03/00259

(30) Foreign Application Priority Data
May 29, 2002 (DE) 10224355.7

(51) Int. Cl. A23G 3/00

(52) U.S. Cl. 426/658

(57) ABSTRACT

The invention relates to a method for the production of a granular to powdery mixture of substances comprising starch. A first component comprising at least one starch is mixed in an extruder with a second component comprising at least water. According to the invention, a) the total water content of the mixture comprising the first component and the second component is less than 40 wt-%, particularly, between 15%-20%; b) during the mixing and cooking process in the extruder, the temperature is between 120° C.-250° C., preferably 160° C.-220° C.; c) the extruder material obtained in the extruder is dried; and d) the dried extruded material is ground and sieved.

The invention relates to a method for producing a mixture of grainy to powdery materials containing a starch, a first component, containing at least one starch being mixed in an extruder with a second component containing at least water.

Binders, based on starch, are used in numerous food products and for technical applications. For this purpose, the dry, powdery binder substance is usually stirred into water and subsequently mixed and processed further with other, usually solid materials. For the further processing to an end product, a portion of the water is withdrawn once again from this mixture of solids and binder.

It is an object of the invention to make available a starch-containing dry binder substance, which can be stirred into water in order to obtain a homogeneous, liquid binder having a total concentration of 1-10% of dry substance. This binder should, for example, have a low viscosity of about 40 mPs to 80 mPs at a concentration of approximately 6% of dry substance.

This objective is accomplished for the method described above owing to the fact that:
a) the total water content of the mixture, containing the first component and the second component, is less than 40% by weight and, in particular, ranges from 15% to 20%,
b) the temperature during the mixing and cooking processes in the extruder is between 120° and 250° C. and preferably ranges from 160° to 220° C.,
c) the extrudate, obtained in the extruder, is dried and
d) the dried extrudate is ground and screened.

Due to the relatively high temperatures during the mixing and cooking processes, there is much evaporation from the extrudate after it leaves the extruder, so that there is no need for additional, energy-intensive measures for drying the extrudate. Accordingly, the extrudate is dried extensively only by being cooled under normal room conditions. The relatively high temperatures also lead to a better solubility of the dry binder product.

Preferably, the maximum screen size during screening is 4 mm and especially 1 mm to 3 mm.

Because of the inventive extrusion conditions, such a coarse screen size is adequate for achieving a granulation, which makes optimum suspension of the products possible. In addition, the technical effort, the energy consumption and the wear of the grinding devices for such a coarse grinding is much less than in the case of fine grinding. Furthermore, the coarser screens, required in conjunction with the inventive coarse grinding, are cheaper and, because of the fines portion contained in the material ground, tend to clog less than do fine screens.

Advisably, the initial water content of the first component is about 10 to 10 to 15% by weight. Additional water is added to the extruder during the mixing process.

Preferably, an acid and/or an alkali are added during the mixing to the mixture containing the starch and water. The viscosity, as well as the color of the binder and, with that, also of the end product, can be affected by such a change in the pH.

The starch-containing component may be flour, especially rye flour. For example, conventional, commercial rye flour with initial water content of about 10 to 15% by weight is advantageous.

The inventive mixing process takes place preferably in a twin-screw extruder, rotating in the same direction at 200 to 1200 rpm, the specific mechanical energy input being, in particular, 120 to 220 Wh/kg.

The inventive, starch-containing, grainy to powdery mixture of materials can be used as binder, the starch-containing mixture of materials being stirred into water for this purpose. Preferred water temperatures range here from 20° to 70° C. and particularly from 30° to 60° C.

The starch-containing mixture of materials proves to be especially advantageous as a binder for cellulose fibers, especially for the production of paper or cardboard.

Further advantageous distinguishing features and possible applications of the inventive method arise out of the following example.

### EXAMPLE

Conventional, commercial rye flour is transferred to a twin-screw extruder rotating in the same direction. The total water content in the extruder is then increased to 20% by weight. The extrusion temperature is of the order of 190° C. The twin-screw extruder is operated at about 600 rpm and produces a specific mechanical energy input of approximately 160-200 Wh/kg. The extrudate, emerging from the twin-screw extruder, dries in air without any special drying effort, because its temperature has been raised sufficiently in the extruder and a sufficient amount of water is evaporated due to the reduction in pressure as the extrudate leaves the extruder. The dry extrudate, so obtained, is subjected to a coarse milling and a coarse classification.

The grainy, dry binder product, so obtained, has excellent water solubility and can be dispersed in water without forming lumps, so that a homogeneous, liquid binder with a concentration of 5 to 10% can be produced.

The liquid binder prepared is used, for example, for the production of paper or cardboard, in order to improve their properties. For this purpose, paper sheets are “drawn” through the inventive suspension, wetting and at least partial penetration of the paper sheet being achieved because of the viscosity, which has been adjusted pursuant to the invention, and because of the homogeneity of the binder, which has been achieved (“surface gluing”).

1. Method for producing a starch mixture of grainy to powdery materials containing starch, comprising mixing in an extruder a first component containing at least one starch with a second component containing at least water,
providing that the total water content of the mixture, containing the first component and the second component, is less than 40% by weight
maintaining the temperature during the mixing and cooking processes in the extruder between 120° and 250° C.
drying the extrudate obtained in the extruder, and
grinding and screening the dried extrudate.

2. The method of claim 1, wherein the maximum screen size during screening is about 4 mm.

3. The method of claim 1, wherein the initial water content of the first component is about 10 to 15% by weight and further comprising adding water to the extruder during the mixing process.

4. The method of claim 1, further comprising adding acid during the mixing to the mixture containing starch and water.

5. The method of claim 1, wherein the component, containing the starch, is flour.

6. The method of claim 1, wherein the component, containing the starch, is conventional, commercial rye flour with an initial water content of about 10 to 15% by weight.

7. The method of claim 1, wherein the mixing process takes place in a twin-screw extruder, rotating in the same direction at 200 to 1200 rpm.

8. The method of claim 1, wherein the specific mechanical energy introduced into the product is about 120 to 220 Wh/kg.

9. The starch-containing, grainy to powdery mixture of materials, produced by the method of claim 1.

10. A method for producing a binder comprising stirring the starch-containing mixture of materials of claim 9 into water.

11. The method according to claim 10, wherein the starch-containing mixture of materials is stirred into water having a temperature of 20° to 70° C.

12. The method according to claim 10, wherein the starch-containing mixture of materials is used as a binder for cellulose fibers.

13. The method of claim 1, wherein the total water content of the mixture, containing the first component and the second component, ranges from 15% to 20%.

14. The method of claim 1, wherein the temperature during the mixing and cooking process in the extruder ranges from 160° to 220° C.

15. The method of claim 1, wherein the maximum screen size during screening ranges from about 1 mm to 3 mm.

16. The method of claim 1, further comprising adding alkali during the mixing to the mixture containing starch and water.

17. The method of claim 1, further comprising adding acid and alkali during the mixing to the mixture containing starch and water.

18. The method of claim 1, wherein the component, containing the starch, is rye flour.

19. The method according to claim 10, wherein the starch-containing mixture of materials is stirred into water having a temperature of 30° to 60° C.

20. The method according to claim 10, wherein the starch-containing mixture of materials is used as a binder for producing paper or cardboard.

21. A binder comprising the starch-containing, grainy to powdery mixture of materials produced by the method of claim 1, and water with which said starch-containing, grainy to powdery mixture of materials has been stirred.

22. A binder for cellulose fibers comprising the starch-containing, grainy to powdery mixture of materials produced by the method of claim 1, and water with which said starch containing, grainy to powdery mixture of materials has been stirred.
